(19) United States
(12) Patent Application Publication
(10) Pub. No.: US 2023/0207242 A1
(43) Pub. Date: Jun. 29, 2023

(54) NON-MAGNETIC PLATE, ELECTROMAGNETIC CONTACTOR, NON-MAGNETIC MATERIAL, AND MANUFACTURING METHOD

(71) Applicant: FUJI ELECTRIC FA COMPONENTS & SYSTEMS CO., LTD., Saitama (JP)

(72) Inventors: Kouetsu TAKAYA, Saitama (JP); Shouta KIKUCHI, Saitama (JP); Masashi SEKIYA, Saitama (JP)

(21) Appl. No.: 18/171,878

(22) Filed: Feb. 21, 2023

Related U.S. Application Data
(63) Continuation of application No. PCT/JP2022/023348, filed on Jun. 9, 2022.

(30) Foreign Application Priority Data
Jul. 8, 2021 (JP) 2021-113302

(51) Int. Cl. H01H 50/36; H01H 50/54; H01H 49/00

(52) U.S. Cl. CPC H01H 50/36; H01H 50/54; H01H 49/00

(57) ABSTRACT

A non-magnetic plate having a thin plate shape and being attachable to and detachable from a shaft of an electromagnet included in an electromagnetic contactor, the non-magnetic plate includes: a hole having a circular shape provided at a center of the non-magnetic plate, into which the shaft is to be fitted; and a cutout provided in connection with a front end portion of the non-magnetic plate and the hole, for having the shaft inserted into the hole through from the front end portion side.

### CROSS-REFERENCE TO RELATED APPLICATIONS

This U.S. non-provisional application is a continuation application of and claims the benefit of priority under 35 U.S.C. § 365(c) from PCT International Application PCT/JP2022/023348 filed on Jun. 9, 2022, which is designated the U.S., and claims priority to Japanese Patent Application No. 2021-113302 filed on Jul. 8, 2021, the entire contents of which are incorporated herein by reference.

### TECHNICAL FIELD

The present disclosure relates to a non-magnetic plate, an electromagnetic contactor, a non-magnetic material, and a manufacturing method.

### BACKGROUND

Patent Document 1 below discloses a configuration in which a non-magnetic plate is arranged outside an armature provided at one end of a spool in a poled electromagnet included in an electromagnetic contactor.

### RELATED ART DOCUMENTS

### Patent Documents

[Patent Document 1] Japanese Laid-Open Patent Application No. 2011-44278

However, the non-magnetic plate of Patent Document 1 has a circular opening at the center, and is configured to have a cylindrical shaft inserted into the opening; therefore, it is not easy to attach or detach the plate with respect to a shaft.

### SUMMARY

The non-magnetic plate according to one embodiment is a non-magnetic plate having a thin plate shape and being attachable to and detachable from a shaft of an electromagnet included in an electromagnetic contactor, that includes: a hole having a circular shape provided at a center of the non-magnetic plate, into which the shaft is to be fitted; and a cutout provided in connection with a front end portion of the non-magnetic plate and the hole, for having the shaft inserted into the hole through from the front end portion side.

### BRIEF DESCRIPTION OF DRAWINGS

FIG. 1 is a cross-sectional view of an electromagnetic contactor according to one embodiment;

FIG. 2 is a cross-sectional view of the electromagnetic contactor according to the one embodiment;

FIG. 3 illustrates an external perspective view of a non-magnetic plate provided in the electromagnetic contactor according to the one embodiment;

FIG. 4 illustrates a plan view of a non-magnetic plate included in the electromagnetic contactor according to the one embodiment;

FIG. 5 is a diagram illustrating a state of the non-magnetic plate being attached in the electromagnetic contactor according to the one embodiment;

FIG. 6 is a diagram illustrating a state of the non-magnetic plate being attached in the electromagnetic contactor according to the one embodiment;

FIG. 7 is a cross-sectional view illustrating a state of the non-magnetic plate being attached in the electromagnetic contactor according to the one embodiment;

FIG. 8 is a perspective cross-sectional view illustrating a state of the non-magnetic plate being attached in the electromagnetic contactor according to the one embodiment;

FIG. 9 is a diagram illustrating an example of a manufacturing method of the non-magnetic plate according to the one embodiment; and

FIG. 10 is a diagram illustrating a conventional manufacturing method of a non-magnetic plate.

### DESCRIPTION OF EMBODIMENTS

In the following, with reference to the drawings, one embodiment will be described. According to one embodiment, a non-magnetic plate that is easily attachable to and detachable from a shaft of an electromagnet included in an electromagnetic contactor, can be provided.

### (Configuration of Electromagnetic Contactor 100)

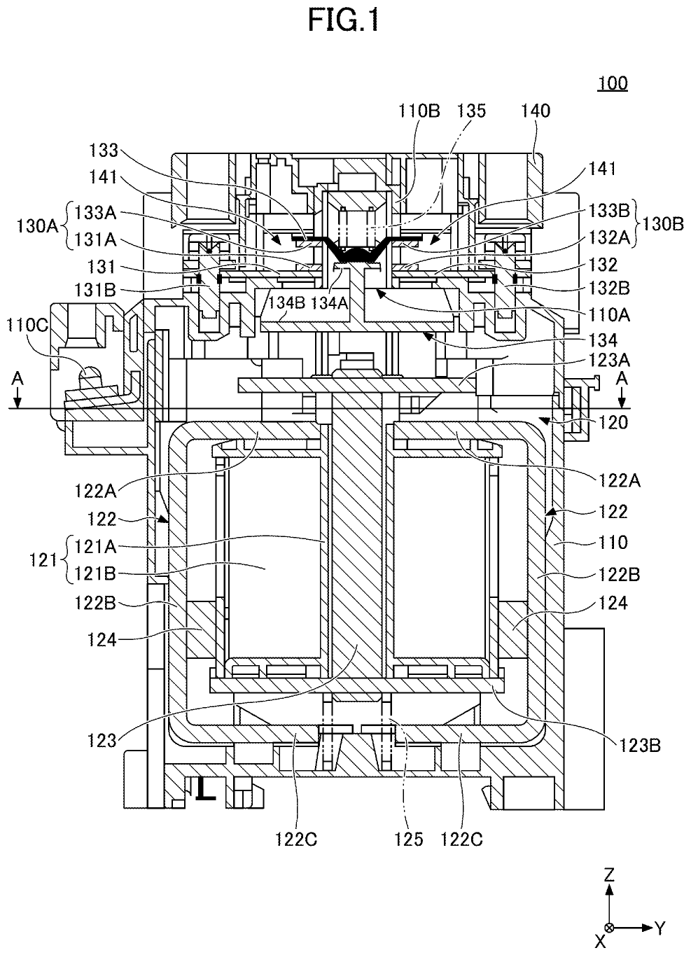

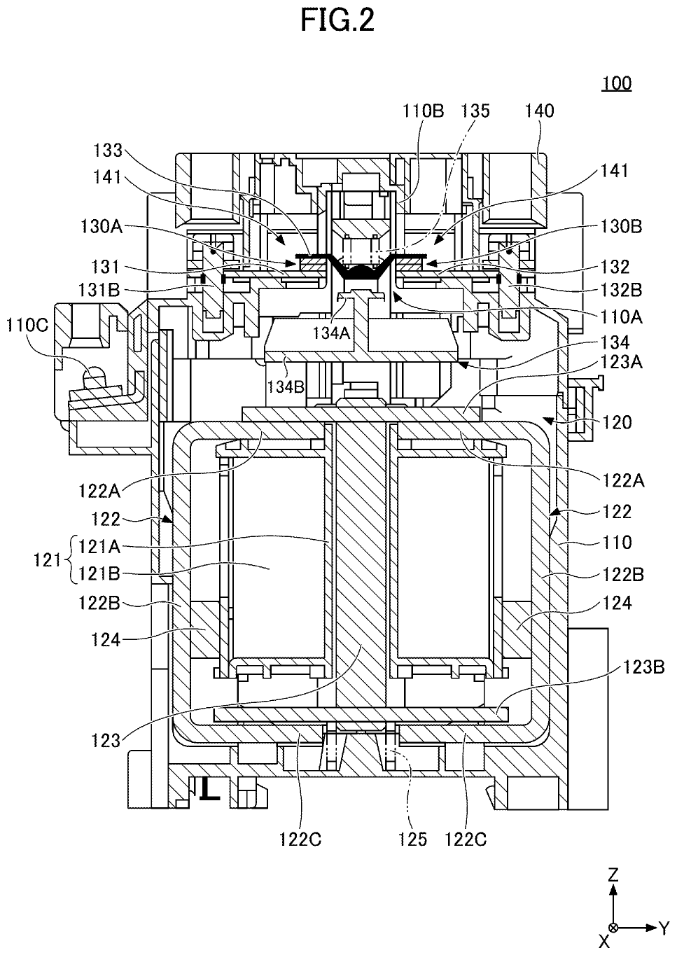

FIGS. 1 and 2 are cross-sectional views of an electromagnetic contactor 100 according to one embodiment. FIG. 1 illustrates the electromagnetic contactor 100 in a switch-off state. FIG. 2 illustrates the electromagnetic contactor 100 in a switch-on state.

Note that in the following descriptions, for the sake of convenience, a direction corresponding to the direction of movement of a movable terminal 133 is defined as the up-down direction (Z-axis direction); a direction corresponding to the longitudinal direction with respect to the movable terminal 133 is defined as the left-right direction (Y-axis direction): and a direction corresponding to the short direction with respect to the movable terminal 133 is defined as the front-back direction (X-axis direction).

As illustrated in FIG. 1, the electromagnetic contactor 100 includes a case 110, an electromagnet 120, a contact mechanism 130, and an upper housing 140.

### <Case 110>

The case 110 is a container-like member having a hollow structure. The case 110 is formed, for example, using an insulating material such as synthetic resin. An opening 110A is formed at the center in the upper surface of the case 110. A coupling member 134 is placed inside the opening 110A.

### <Electromagnet 120>

The electromagnet 120 is provided inside the case 110. The electromagnet 120 generates magnetic force to move the movable terminal 133 in the up-down direction. The electromagnet 120 includes an electromagnetic coil 121, a pair of left and right fixed cores 122, a movable core 123, a permanent magnet 124, and a coil spring 125.

The electromagnetic coil 121 includes a bobbin 121A and an excitation coil 121B. The excitation coil 121B is formed by winding a coil wire multiple times around the bobbin 121A having a cylindrical shape, and has a cylindrical shape surrounding the bobbin 121A. Note that the excitation coil 121B is electrically connected to an external connection terminal 110C provided to be protruding from the side surface of the case 110, and electric power is supplied from the outside via the external connection terminal 110C.

The pair of left and right fixed cores 122 have shapes symmetrical with each other. Each of the left and right pair of fixed cores 122 has a shape in which the top and bottom of a flat plate-like member are folded at right angles toward the inside (toward the center of the electromagnetic coil 121). Accordingly, each of the pair of left and right fixed cores 122 is configured to have a top wall portion 122A, a side wall portion 122B, and a bottom wall portion 122C, and thereby, can cover the upper side, the lower side, and the lateral side of the electromagnetic coil 121. The fixed core 122 is formed, for example, using iron.

The movable core 123 has a shaft shape, and is arranged in the cylinder of the electromagnetic coil 121. The movable core 123 can move in the up-down direction (in the Z-axis direction) in the cylinder of the electromagnetic coil 121. The movable core 123 is formed, for example, using iron. Note that the movable core 123 has a first plate-like part 123A having a horizontal flat plate shape at the upper end portion. In addition, the movable core 123 has a second plate-like part 123B having a horizontal flat plate shape in the lower end portion.

The coil spring 125 is provided to be extendable and contractible in the up-down direction (the Z-axis direction) between the inner bottom surface of the case 110 and the lower end surface of the movable core 123. The coil spring 125 biases the movable core 123 upward (in the Z-axis positive direction).

The permanent magnet 124 is fixed to the inner surface of the vertical wall portion of the fixed core 122, and provided to face the outer peripheral surface of the excitation coil 121B.

### <Contact Mechanism 130>

The contact mechanism 130 is provided on the upper side of the case 110. The contact mechanism 130 includes a first fixed terminal 131, a second fixed terminal 132, a movable terminal 133, a coupling member 134, and a coil spring 135.

The first fixed terminal 131 is a horizontal flat plate-like member having electrical conductivity. The first fixed terminal 131 is provided on the upper surface of the case 110 at a location shifted toward the left side (the negative side of the Y-axis) relative to the center of the contact mechanism 130. The first fixed terminal 131 has a longitudinal shape extending in the left-right direction (the Y-axis direction). The first fixed terminal 131 includes a first fixed contact 131A on the upper surface at its front end portion (the end on the positive side of the Y-axis). In addition, the first fixed terminal 131 is screwed to be fixed to the upper surface of the case 110 with a screw 131B penetrating the first fixed terminal 131 at its tip (the end on the negative side of the Y-axis) The first fixed terminal 131 is connected to first wiring (not illustrated) that is drawn out to the outside from the first fixed terminal 131.

The second fixed terminal 132 is a horizontal flat plate-like member having electrical conductivity. The second fixed terminal 132 is provided on the upper surface of the case 110 at a location shifted toward the right side (the positive side of the Y-axis) relative to the center of the contact mechanism 130. In addition, the second fixed terminal 132 is provided at the same height position as the first fixed terminal 131. The second fixed terminal 132 has a longitudinal shape extending in the left-right direction (the Y-axis direction). The second fixed terminal 132 includes a second fixed contact 132A on the upper surface at its front end portion (the end on the negative side of the Y-axis). In addition, the second fixed terminal 132 is screwed to be fixed to the upper surface of the case 110 with a screw 132B penetrating the second fixed terminal 132 at its tip (the end on the positive side of the Y-axis) The second fixed terminal 132 is connected to second wiring (not illustrated) that is drawn out to the outside from the second fixed terminal 132.

The movable terminal 133 is a horizontal flat plate-like member having electrical conductivity. The movable terminal 133 is provided at the center of the contact mechanism 130 in the left-right direction (the Y-axis direction), and is provided on the upper side (positive side of the Z-axis) of the first fixed terminal 131 and the second fixed terminal 132 in the up-down direction (the Z-axis direction). The movable terminal 133 has a longitudinal shape extending in the left-right direction (the Y-axis direction). The movable terminal 133 includes a first movable contact 133A on the lower surface at its left end portion (the end on the negative side of the Y-axis). The first movable contact 133A faces the first fixed contact 131A, and can be in contact with or separated from the first fixed contact 131A. In addition, the movable terminal 133 includes a second movable contact 133B on the lower surface at its right end part (the end on the positive side of the Y-axis). The second movable contact 133B faces the second fixed contact 132A, and can be in contact with or separated from the second fixed contact 132A.

The coupling member 134 is a member that moves the movable terminal 133 in the up-down direction (the Z-axis direction) together with the movable core 123, by coupling the movable terminal 133 with the movable core 123. The coupling member 134 is arranged in the opening 110A formed at the center of the upper surface of the case 110. A first connection portion 134A having a flat plate shape provided at the upper end portion of the coupling member 134 is fixed to the lower surface of the movable terminal 133 at the center by any fixing means. A second connection portion 134B having a flat plate shape provided on the lower end surface of the coupling member 134 is fixed to the upper end portion of the movable core 123 by any fixing means.

The coil spring 135 is provided in the internal space of a support member 110B, which is provided to be protruding upward from the center of the upper surface of the case 110, to be extendable and contractible in the up-down direction (the Z-axis direction) between the ceiling surface of the internal space and the center of the upper surface of the movable terminal 133. The coil spring 135 biases the movable terminal 133 downward (in the Z-axis negative direction).

### <Upper Housing 140>

The upper housing 140 is provided at an upper portion of the case 110 so as to surround the periphery of the contact mechanism 130. For example, the upper housing 140 is formed using an insulating resin material. The upper housing 140 includes a pair of left and right arc-extinguishing chambers 141. A first contact part 130A is housed in the arc-extinguishing chamber 141 on the left side (the negative side of the Y-axis). The first contact part 130A corresponds to a pair of the first fixed contact 131A and the first movable contact 133A. A second contact part 130B is housed in the arc-extinguishing chamber 141 on the right side (the positive side of the Y-axis). The second contact part 130B corresponds to a pair of the second fixed contact 132A and the second movable contact 133B.

### (Operations of Electromagnetic Contactor 100)

In the electromagnetic contactor 100 according to the one embodiment, when the excitation coil 121B is not energized, the movable core 123 is biased upward (in the Z-axis positive direction) by the biasing force of the coil spring 125. Accordingly, the movable terminal 133 coupled with the movable core 123 via the coupling member 134 moves upward (in the Z-axis positive direction), to transition to a state of being separated upward from the first fixed terminal 131 and the second fixed terminal 132 (in the Z-axis positive direction). Therefore, as illustrated in FIG. 1, the electromagnetic contactor 100 transitions to a state where the first fixed terminal 131 and the second fixed terminal 132 are not conductive with each other (i.e., switch-off state).

On the other hand, in the electromagnetic contactor 100 according to the one embodiment, when the excitation coil 121B is energized, a magnetic attraction force that overcomes the biasing force of the coil spring 125 is generated between the fixed core 122 and the movable core 123. This magnetic attraction force moves the movable core 123 downward (in the Z-axis negative direction). At this time, the movable terminal 133 coupled with the movable core 123 via the coupling member 134 moves downward (in the Z-axis negative direction). Accordingly, the first movable contact 133A and the second movable contact 133B provided at the movable terminal 133 contact the first fixed contact 131A provided at the first fixed terminal 131 and the second fixed contact 132A provided at the second fixed terminal 132, respectively. The contact pressure at this time is increased by the biasing force of the coil spring 135. As a result, the electromagnetic contactor 100 transitions to a state where the first fixed terminal 131 and the second fixed terminal 132 are conductive with each other (i.e., switch-on state).

Then, in the electromagnetic contactor 100 according to the one embodiment, when the excitation coil 121B is not energized, the movable core 123 is biased upward (in the Z-axis positive direction) by the biasing force of the coil spring 125. Accordingly, the movable terminal 133 coupled with the movable core 123 via the coupling member 134 moves upward (in the Z-axis positive direction), to transition to a state of being separated from the first fixed terminal 131 and the second fixed terminal 132 upward (in the Z-axis positive direction). Therefore, as illustrated in FIG. 1, the electromagnetic contactor 100 transitions to a state where the first fixed terminal 131 and the second fixed terminal 132 are not conductive with each other (i.e., switch-off state).

### (Configuration of Non-Magnetic Plate 150)

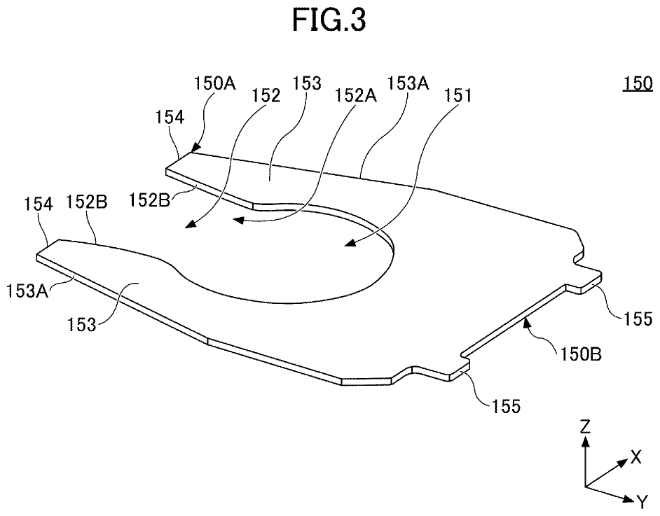

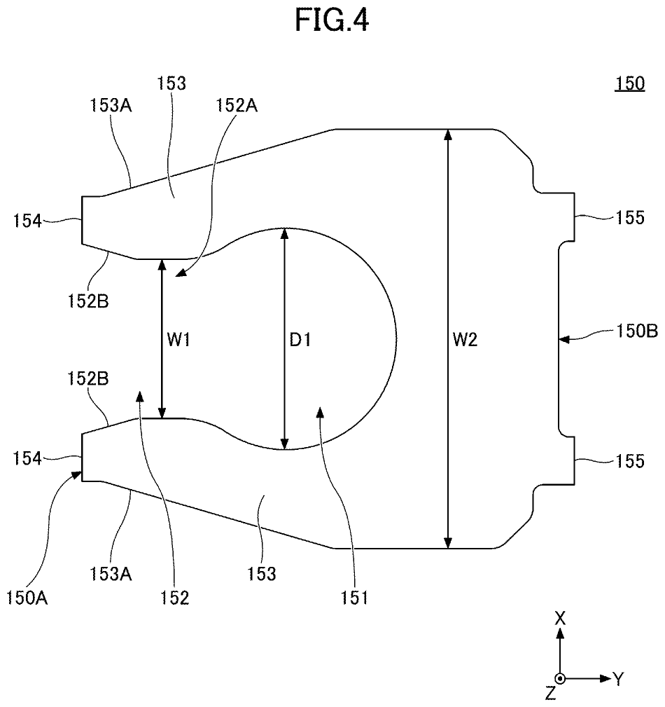

FIG. 3 illustrates an external perspective view of a non-magnetic plate 150 provided in the electromagnetic contactor 100 according to the one embodiment. FIG. 4 illustrates a plan view of the non-magnetic plate 150 provided in the electromagnetic contactor 100 according to the one embodiment.

The non-magnetic plate 150 illustrated in FIGS. 3 and 4 is a thin plate-like member attachable to and detachable from the movable core 123 (an example of a “shaft”) of the electromagnet included in the electromagnetic contactor 100. The non-magnetic plate 150 is formed using a thin plate-like non-magnetic material (e.g., a polyester film, a stainless steel plate, brass, etc.). As illustrated in FIGS. 3 and 4, the outer shape of the non-magnetic plate 150 is generally rectangular.

Note that the non-magnetic plate 150 has a front end portion 150A at the end on the negative side of the Y-axis and a rear end portion 150B at the end on the positive side of the Y-axis, and is attached to the movable core 123 from the front end portion 150A side.

As illustrated in FIGS. 3 and 4, the non-magnetic plate 150 includes a hole 151 and a cutout 152.

The hole 151 is provided at the center of the non-magnetic plate 150. The hole 151 has a circular shape in plan view. The hole 151 is fitted with the cylinder-like movable core 123. Therefore, the inner diameter of the hole 151 is approximately the same as the outer diameter of the movable core 123.

The cutout 152 is a portion formed by cutting off part of the peripheral portion surrounding the hole 151 in the non-magnetic plate 150. The cutout 152 is provided in connection with the front end portion 150A and the hole 151 of the non-magnetic plate 150. The cutout 152 is provided to have the movable core 123 inserted from the front end portion 150A side into the hole 151.

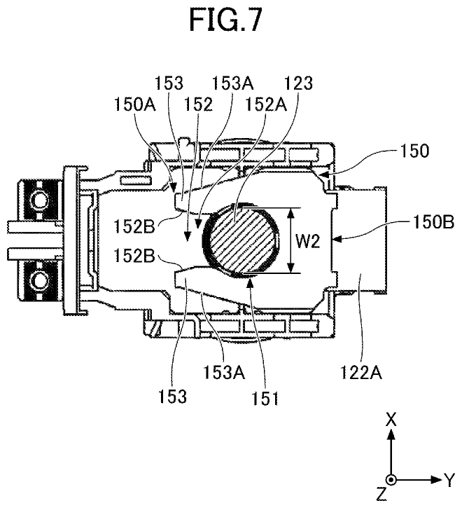

As illustrated in FIG. 4, the cutout 152 has a narrow portion 152A at which the opening width is the smallest. As illustrated in FIG. 4, the opening width W1 of the narrow portion 152A is smaller than the inner diameter D1 of the hole 151. In addition, the opening width W1 of the narrow portion 152A is smaller than the outer diameter W2 of the movable core 123 (see FIG. 7).

In addition, as illustrated in FIGS. 3 and 4, each of a pair of inner edges 152B of the cutout 152 has a tapered shape (i.e., a linear shape inclined with respect to the Y-axis) so as to make the opening width gradually greater from the narrow portion 152A toward the front end portion 150A.

In addition, as illustrated in FIGS. 3 and 4, by having the hole 151 and the cutout 152 formed, the non-magnetic plate 150 has a pair of arms 153 on both outside of the hole 151 and the cutout 152 in the width direction (in the X-axis direction). In particular, in the non-magnetic plate 150, the outer edge 153A of each of the pair of arms 153 has a tapered shape (i.e., a linear shape inclined to the Y-axis) so as to make the outer width in the portions having the pair of arms 153 gradually smaller toward the front end portion 150A.

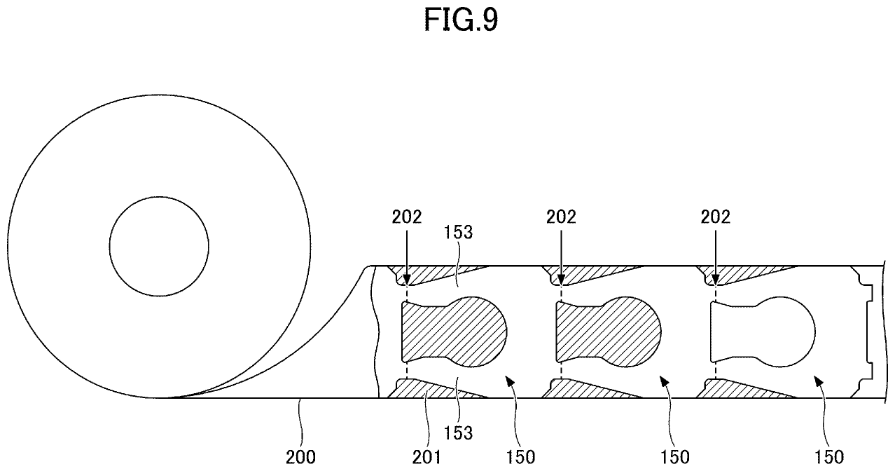

In addition, as illustrated in FIGS. 3 and 4, the non-magnetic plate 150 includes a pair of first cut faces 154 at the front end portion 150A (i.e., the front end portion of each of the pair of arms 153). The first cut face 154 is formed by cutting a coupling portion with the rear end portion 150B of another non-magnetic plate 150 coupled with the front side (Y-axis negative side) of the non-magnetic plate 150 (see FIG. 9).

In addition, as illustrated in FIGS. 3 and 4, the non-magnetic plate 150 includes a pair of second cut faces 155 at the rear end portion 150B. The second cut face 155 is formed by cutting a coupling portion with the front end portion 150A of another non-magnetic plate 150 coupled with the rear side (Y-axis positive side) of the non-magnetic plate 150 (see FIG. 9). In other words, the width of the second cut face 155 is the same as the width of the first cut face 154.

Note that as illustrated in FIGS. 3 and 4, in the non-magnetic plate 150, the width W2 (width in the X-axis direction) of a portion on the rear side of the pair of arms 153 is constant. This width W2 is equal to the width of a belt-like non-magnetic material 200 (see FIG. 9) used when manufacturing the non-magnetic plate 150.

Accordingly, in the non-magnetic plate 150, the portion on the rear side of the pair of arms 153 has an area large enough to be held by fingers, tools, and the like. Therefore, the non-magnetic plate 150 can be easily attached to and detached from the movable core 123 by holding the portion of the plate on the rear side of the pair of arms 153 with fingers, tools, and the like.

### (Method of Attaching Non-Magnetic Plate 150)

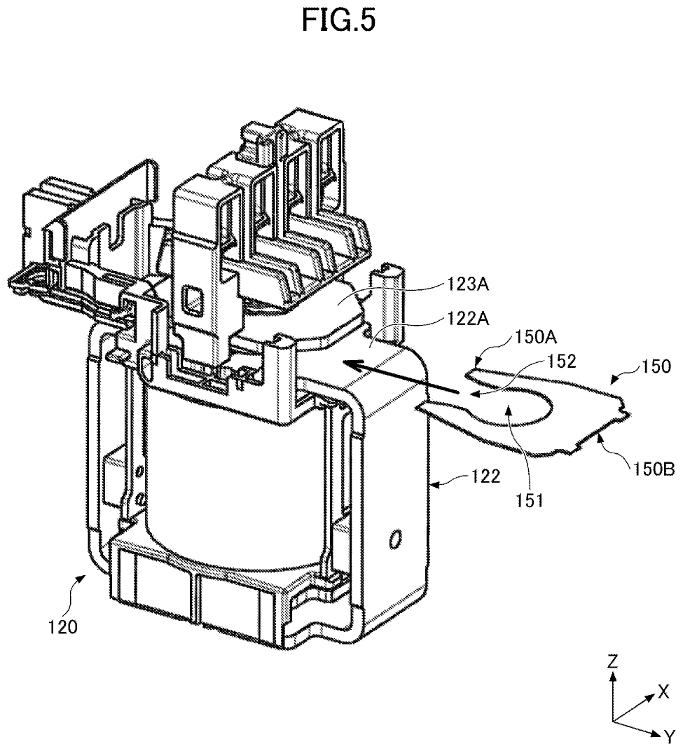

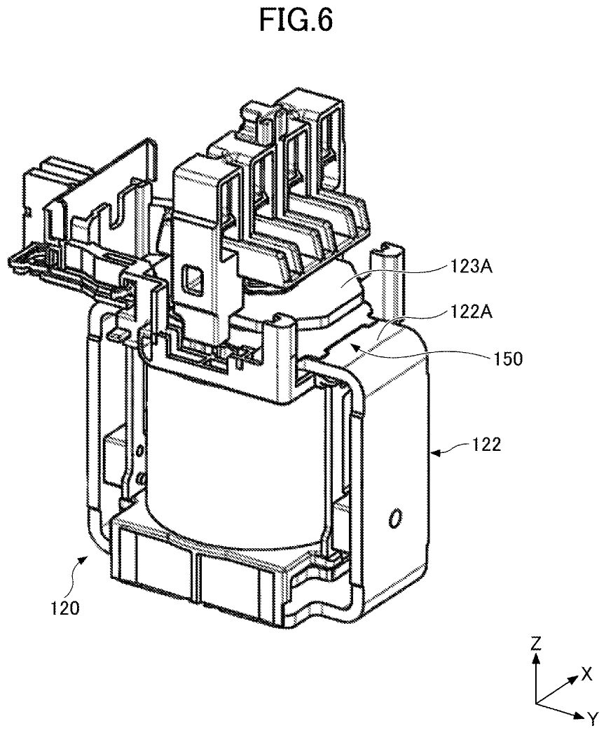

FIGS. 5 and 6 are diagrams illustrating a state of the non-magnetic plate 150 being attached in the electromagnetic contactor 100 according to the one embodiment. Note that in FIGS. 5 and 6, illustration of the case 110 is omitted.

As illustrated in FIGS. 5 and 6, the non-magnetic plate 150 is inserted from the right side of the electromagnet 120 into a gap between the first plate-like part 123A of the movable core 123 and the top wall portion 122A of the fixed core 122, to be attached to the movable core 123 present in the gap.

Here, by having the cutout 152 on the front end portion 150A side, the non-magnetic plate 150 can be pushed from the front end portion 150A side toward the movable core 123 to have the movable core 123 inserted into the cutout 152, and thereby, the movable core 123 can be easily fitted into the hole 151.

### (State of Non-Magnetic Plate 150 Being Attached)

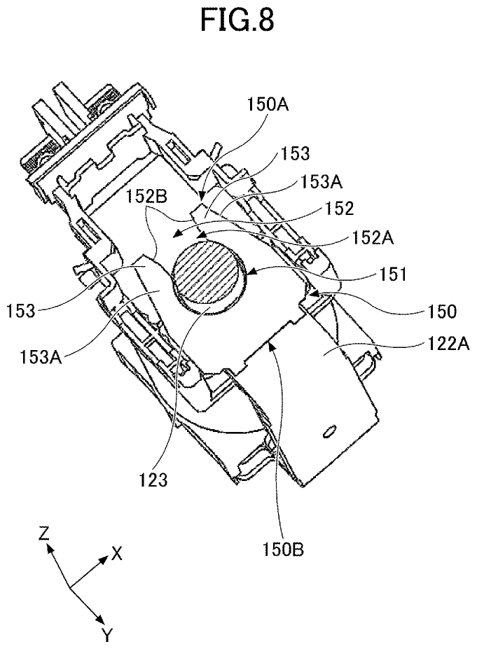

FIG. 7 is a cross-sectional view illustrating a state of the non-magnetic plate 150 being attached in the electromagnetic contactor 100 according to the one embodiment. FIG. 8 is a perspective cross-sectional view illustrating a state of the non-magnetic plate 150 being attached in the electromagnetic contactor 100 according to the one embodiment. Note that FIGS. 7 and 8 illustrate a cross section of the electromagnetic contactor 100 when cut along a cross section line A-A illustrated in FIG. 1. Here, in FIGS. 7 and 8, illustration of the case 110 is omitted.

As illustrated in FIGS. 7 and 8, the non-magnetic plate 150 is attached to the movable core 123 by fitting the movable core 123 into the hole 151 through the cutout 152.

As illustrated in FIGS. 7 and 8, the non-magnetic plate 150 has the narrow portion 152A provided in the cutout 152, and the opening width W1 of the narrow portion 152A is smaller than the outer diameter W2 of the movable core 123. Therefore, the non-magnetic plate 150 hardly falls out of the movable core 123 in a state of the movable core 123 being fitted in the hole 151.

In addition, as illustrated in FIGS. 7 and 8, each of the pair of inner edges 152B of the cutout 152 has a tapered shape (i.e., a linear shape inclined with respect to the Y-axis) so as to make the opening width gradually greater from the narrow portion 152A toward the front end portion 150A. Therefore, the non-magnetic plate 150 can have the movable core 123 easily inserted into the cutout 152 upon being attached to the movable core 123.

Note that in the non-magnetic plate 150, when the movable core 123 is inserted into the cutout 152, the movable core 123 elastically deforms the pair of arms 153 while widening the narrow portion 152A, and thereby, the movable core 123 can pass through the narrow portion 152A.

Here, as illustrated in FIGS. 7 and 8, in the non-magnetic plate 150, the outer edge 153A of each of the pair of arms 153 has a tapered shape (i.e., a linear shape inclined to the Y-axis) so as to make the outer width in the portions having the pair of arms 153 gradually smaller toward the front end portion 150A. Accordingly, the non-magnetic plate 150 has the pair of arms 153 that elastically deform easily, i.e., has the narrow portion 152A that can be widened easily by the movable core 123.

### (Manufacturing Method of Non-Magnetic Plate 150)

FIG. 9 is a diagram illustrating an example of a manufacturing method of the non- magnetic plate 150 according to the one embodiment.

As illustrated in FIG. 9, in a manufacturing method of the non-magnetic plate 150 according to the one embodiment, the non-magnetic plate 150 can be formed by coupling multiple non-magnetic plates 150 with respect to a non-magnetic material 200 that has a belt-like thin plate shape extending linearly with a certain width.

Specifically, as illustrated in FIG. 9, by pulling out part of the non-magnetic material 200 rolled with multiple turns and removing residual portions 201 (part indicated with oblique lines) from the pulled-out part, multiple non-magnetic plates 150 coupled with each other in a row can be formed (formation step).

In this way, the non-magnetic material 200 in a state of having multiple non-magnetic plates 150 formed to be coupled may be provided to the user and the like. Accordingly, the non-magnetic material 200 allows the user to manage collectively the multiple non-magnetic plates 150 easily.

In particular, as illustrated in FIG. 9, in each of the multiple non-magnetic plates 150, the width W2 of the part on the rear side of the pair of arms 153 is equal to the width of the non-magnetic material 200. In other words, part of the non-magnetic plate 150 can be used as it is without cutting the non-magnetic material 200; therefore, the non-magnetic material 200 can be used effectively, and the area of the residual portion 201 that is to be discarded can be reduced.

Further, in the non-magnetic material 200 according to the one embodiment, the non-magnetic plates 150 can be separated individually, by cutting a coupling portion 202 (a coupling portion between the front end portion 150A of one non-magnetic plate 150 and the rear end portion 150B of another non-magnetic plate 150) of the two non-magnetic plates 150 coupled with each other (separation step).

It is favorable that the non-magnetic plate 150 in the one embodiment has the shape described as above. However, it is not limited as such; the non-magnetic plate 150 in the one embodiment may have any shape as long as the shape has at least the hole 151 and the cutout 152.

### (Conventional Method of Manufacturing Non-Magnetic Plate 150)

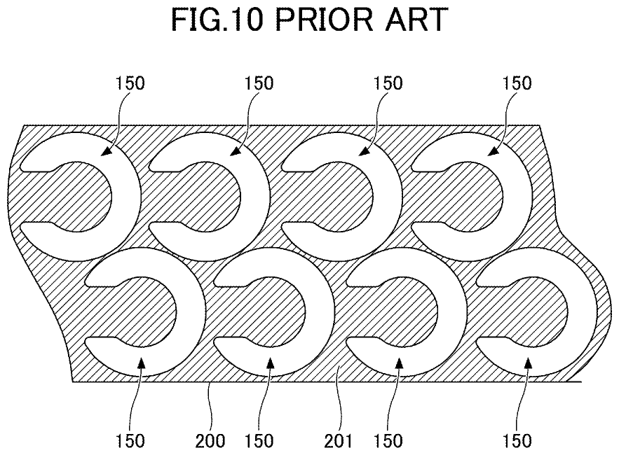

FIG. 10 is a diagram illustrating a conventional manufacturing method of a non-magnetic plate 150. As illustrated in FIG. 10, the conventional non-magnetic plate 150 has a circular outer shape. Therefore, as illustrated in FIG. 10, in the conventional manufacturing method of the non-magnetic plate 150, a residual portion 201 (part indicated with oblique lines) is removed from a non-magnetic material 200 having a belt-like thin plate shape, to form multiple non-magnetic plates 150 separated from each other. Therefore, in the conventional manufacturing method of the non-magnetic plate 150, it has been difficult to easily manage the multiple non-magnetic plates 150 collectively. In addition, in the conventional manufacturing method of the non-magnetic plate 150, it has been difficult to reduce the area of the residual portion 201 that is to be discarded.

As above, preferable embodiments according to the present invention have been described. Note that the present invention is not limited to these embodiments, and various changes and modifications can be made within the scope of the present invention as set forth in the claims.

1. A non-magnetic plate having a thin plate shape and being attachable to and detachable from a shaft of an electromagnet included in an electromagnetic contactor, the non-magnetic plate comprising:
a hole having a circular shape provided at a center of the non-magnetic plate, into which the shaft is to be fitted; and
a cutout provided in connection with a front end portion of the non-magnetic plate and the hole, for having the shaft inserted into the hole through from the front end portion side.

2. The non-magnetic plate as claimed in claim 1, wherein the cutout includes a narrow portion having an opening width being smaller than an inner diameter of the hole, and smaller than an outer diameter of the shaft.

3. The non-magnetic plate as claimed in claim 2, wherein an opening width of the cutout gradually becomes greater from the narrow portion toward the front end portion.

4. The non-magnetic plate as claimed in claim 1, wherein the front end portion has a first cut face formed by cutting a coupling portion with a rear end portion of another non-magnetic plate connected to a front side of the non-magnetic plate, and
a rear end portion has a second cut face formed by cutting a coupling portion with a front end portion of yet another non-magnetic plate connected to a rear side of the non-magnetic plate.

5. The non-magnetic plate as claimed in claim 1, further comprising:
a pair of arms on both outer sides of the hole and the cutout,
wherein an outer width at the pair of arms of the non-magnetic plate gradually decreases toward the front end portion.

6. An electromagnetic contactor comprising:
an electromagnet having a shaft; and
the non-magnetic plate as claimed in claim 1 attached to the shaft.

7. A non-magnetic material having a belt shape extending linearly with a constant width, and having multiple instances of the non-magnetic plate as claimed in claim 1 formed to be coupled with each other.

8. A manufacturing method of a non-magnetic material having a belt-like thin plate shape, the manufacturing method comprising:
a formation step of having multiple instances of the non-magnetic plate as claimed in claim 1 formed to be coupled with each other along the non-magnetic material.

9. The manufacturing method as claimed in claim 8, further comprising:
a separation step of separating a non-magnetic plate at a coupling portion from the non-magnetic material having the multiple non-magnetic plates formed to be coupled with each other along the non-magnetic material in the formation step.
